(19) United States
(12) Patent Application Publication
(10) Pub. No.: US 2017/0150297 A1
(43) Pub. Date: May 25, 2017

(54) DISPLAY DEVICE, WHICH IS EQUIPPED WITH A WIRELESS INTERFACE, FOR THE OPERATING STATE OF A SWITCH DEVICE

(71) Applicant: EATON ELECTRICAL IP GMBH & CO. KG, Schoenefeld (DE)

(72) Inventor: Georg REIDT, Swisttal (DE)

(21) Appl. No.: 15/300,281

(22) PCT Filed: Feb. 24, 2015
(86) PCT No.: PCT/EP2015/053835

§ 371 Date: Sep. 29, 2016

(30) Foreign Application Priority Data
Apr. 2, 2014 (DE) 10 2014 104 658.7

(51) Int. Cl. H04W 4/00; H04W 76/06; H04W 76/02

(52) U.S. Cl. CPC H04W 4/008; H04W 76/023; H04W 76/06

(57) ABSTRACT

A display device has a wireless interface, via which a communication between the display device and a unit configured to communicate with the display device is allowed; a multicolor display element for displaying the operating state of a switch device which is connected to the display device; and a controller which is configured to control the multicolor display element and the communication via the wireless interface and which is additionally configured to activate the wireless interface and to initiate a log-in process for connecting the display device to the unit via the wireless interface upon a specified event, to transmit data to the connected unit via the wireless interface, and to initiate a log-out process for interrupting the connection between the display device and the connected unit after the data transmission process has ended.

### CROSS-REFERENCE TO RELATED APPLICATIONS

This application is a U.S. national stage application under 35 U.S.C. §371 of International Application No. PCT/EP2015/053835, filed on Feb. 24, 2015, and claims benefit to German Patent Application No. DE 10 2014 104 658.7, filed on April 2, 2014. The International Application was published in German on Oct. 8, 2015, as WO 2015/149996 A1 under PCT Article 21(2).

### FIELD

The invention relates to a display apparatus, which is equipped with a wireless interface, for the operating state of a switch apparatus.

### BACKGROUND

A switch apparatus having a radio module and deactivation function is known from the German Offenlegungsschrift DE 10 2012 106 923 A1. Information about the operating state of the switch apparatus can be provided in a wirelessly retrievable manner via the radio module. A display element in the form of a multicolor LED which can show a color depending on an operating parameter of the switch apparatus can be provided on the radio module.

### SUMMARY

An aspect of the invention provides a display apparatus, comprising: a wireless interface, configured to allow communication between the display apparatus and a communication device configured to communicate with the display apparatus; a multicolor display element configured to display an operating state of a switch apparatus which is connected to the display apparatus; and a controller, configured to control the multicolor display element and the communication via the wireless interface, wherein the controller is further configured to activate the wireless interface and to initiate a log-in process for connecting the display apparatus to the device via the wireless interface when a specified event occurs, to transmit data to the communication device via the wireless interface in a data transmission process, and to initiate a log-out process for breaking a connection between the display apparatus and the communication device after the data transmission process has ended.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a block diagram of an embodiment of a display apparatus, which is equipped with a wireless interface, for the operating state of a switch apparatus according to the invention; and

FIG. 2 is a flow diagram of an embodiment of a method for controlling a connection of a display apparatus to a communication device according to the invention.

### DETAILED DESCRIPTION

In an embodiment the present invention provides an improved display apparatus, which is equipped with a wireless interface, for the operating state of a switch apparatus.

An aspect of the present invention is based on the idea of configuring a display apparatus, which is equipped with a wireless interface, for the operating state of a switch apparatus by means of a log-in and log-out procedure for the wireless connection to an external device such that a precise sequence of logging in and logging out of the external device is defined and errors in the connection of the external device to a plurality of such display apparatuses can be prevented. Apart from this, the invention ensures that the wireless interface is not constantly activated, which can be undesirable in certain operating environments, but rather is only activated when a specified event occurs, such as a critical operating state of the connected switch apparatus, and is automatically deactivated again after the end of a data transmission via the wireless interface.

An embodiment of the invention relates to a display apparatus comprising a wireless interface which allows communication between the display apparatus and a device configured to communicate with the display apparatus, a multicolor display for displaying the operating state of a switch apparatus connected to the display apparatus, and a controller which is configured to control the multicolor display element and the communication via the wireless interface and which is additionally configured to activate the wireless interface and to initiate a log-in process for connecting the display apparatus to the device via the wireless interface when a specified event occurs, to transmit data to the connected device via the wireless interface, and to initiate a log-out process for breaking the connection between the display apparatus and the connected device after the data transfer process has ended.

The controller can be configured to detect the activation of a push button and/or the occurrence of a certain operating state of the switch apparatus connected to the display apparatus as the specified event.

The controller can additionally be configured to detect an activation command from the connected device as the end of the data transmission.

Additionally, the controller can be configured to activate the multicolor display apparatus in order to display a specified operating state of the switch apparatus connected to the display apparatus after the connection has been broken between the display apparatus and the connected device.

Finally, the controller can be configured to transmit, to the connected device, service notifications and/or operating parameters of the switch apparatus connected to the display apparatus as data.

The display apparatus can have a manual activation element, which is connected to the controller and can in particular be locked mechanically, and the wireless interface can be a radio module which is integrated in the activation element together with the multicolor display element. The radio module can be configured to transmit data according to a standard such as IEEE 802.15.1 (Bluetooth®, in particular Bluetooth® Low Energy), IEEE 802.11 (Wireless Local Area Network-WLAN), ISO 14443, 18092, 21481 ECMA 340, 352, 356, 362, ETSI TS 102 190 (Near Field Communication-NFC). The manual activation element can, for example, be designed such that it can be locked mechanically by means of a lock in order to prevent unauthorized activation.

A further embodiment of the invention relates to a communication device comprising a wireless interface, which has a processor that is programmed such that the communication device can communicate with a display apparatus according to any of the preceding claims via the wireless interface and can receive data from the display apparatus by means of data transmission and can display it on a screen and in particular can generate a confirmation command to end the data transmission and transmit it to the display apparatus. In particular, the communication device can be a portable computer, tablet PC, mobile telephone, smartphone, PDA (personal digital assistant) or data glasses.

A further embodiment of the invention relates to a method for controlling a connection of a display apparatus according to the invention and as described herein, comprising a communication device according to the invention and as described herein, said method comprising the following steps: detecting a specified event, activating the wireless interface of the display apparatus depending on the detection of the specified event, initiating a log-in process for connecting the display apparatus to the communication device via the wireless interface, transmitting data to the connected communication device via the wireless interface, detecting the end of the data transmission and initiating a log-out process for breaking the connection between the display apparatus and the connected device.

The step of detecting a specified event can comprise detecting the activation of a push button and/or detecting the occurrence of a certain operating state of a switch apparatus connected to the display apparatus, and/or the step of detecting the end of the data transmission can comprise the receipt of a confirmation command from the connected communication device, and/or the method can comprise, as a further step, activating the multicolor display element to display a specified operating state of a switch apparatus connected to the display apparatus after the connection has been broken between the display apparatus and the connected device.

The method can be implemented as part of firmware of the display apparatus, which firmware is executed by the controller to operate the display apparatus.

The advantages and possible applications of the present invention will become clear from the following description in conjunction with the embodiments shown in the drawings.

In the following description, elements that are the same, have the same function or are functionally related may be provided with the same reference numerals. Absolute values are only stated below by way of example and are not be understood to limit the invention.

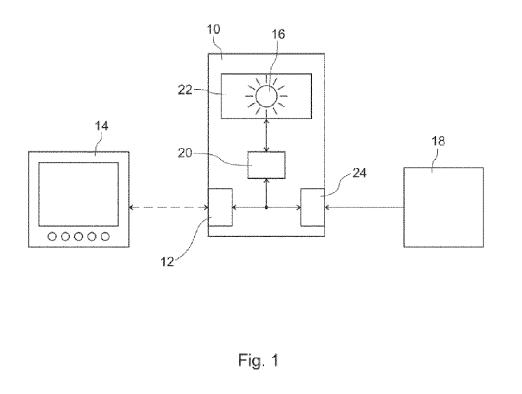

FIG. 1 shows a display apparatus 10 according to the invention, which is connected to a circuit breaker, a motor starter, a motor protection switch or a similar switch apparatus 18 via an interface 24 by means of a wired or wireless connection in order to receive data from the switch apparatus 18, in particular data relating to the operating state of the switch apparatus 18. Data received via the interface 24 from the switch apparatus 18 is processed by a controller 20 of the display apparatus, which controller is configured accordingly by firmware set up in a memory of the controller 20.

The display apparatus 10 further comprises a multicolor indicator (MCI) in the form of a multicolor light-emitting diode 16 which is activated by the controller 20. The multicolor light-emitting diode 16 is integrated in a push button 22, which is likewise connected to the controller 20, which can therefore detect activations of the push button 22. The push button 22 can be locked by a mechanism (not shown) such that it can no longer be activated. As a result, unauthorized or unintentional activation can be prevented. The display apparatus 10 can, for example, be designed as a command and signaling device from the applicant's RMQ-Titan® range and have an illuminated push button, which implements the push button 22 and the multicolor light-emitting diode 16. Alternatively, the display apparatus 10 can be designed as a toggle switch, in which a multicolor light-emitting diode is integrated, for example. The toggle switch can have various positions in order to activate various functions of the display apparatus 10 as will be described below. A push button is therefore not understood in this case to be only a simple push-button switch with two switching states, but also more complex switching elements having a plurality of switching states, such as rotary switches or toggle switches having two, three or more different switching states.

As a further communication interface, the display apparatus 10 has a radio module 12. Instead of a radio module, another wireless communication module can be used, for example an infrared communication module. The radio module 12 can be set up to communicate data according to various wireless transmission standards such as IEEE 802.15.1 (Bluetooth®, in particular Bluetooth® Low Energy), IEEE 802.11 (wireless local area network-WLAN), ISO 14443, 18092, 21481 ECMA 340, 352, 356, 362, ETSI TS 102 190 (near field communication-NFC). Of course, other wireless transmission standards are also possible, in particular the manufacturer's own standards or mobile communications standards.

The display apparatus 10 can, for example, be fitted in the door of a switch cabinet such that the multicolor light-emitting diode 16 and its color display can be seen easily and can indicate important, binary information about the operating state of the switch apparatus 18. More complex information, such as measured values of the switch apparatus, can be transmitted by the display apparatus 10 via the radio module 12 by means of data communication to a further device, such as a tablet PC 14, that likewise has a radio module and can be connected via a wireless connection, for example a Bluetooth® connection to the display apparatus 10, for data communication.

Although the tablet PC 14 is mentioned hereinafter as the communication partner of the display apparatus 10, the other devices already mentioned at the beginning can of course also be used as the communication partner, as well as in principle any data processing device having a radio module.

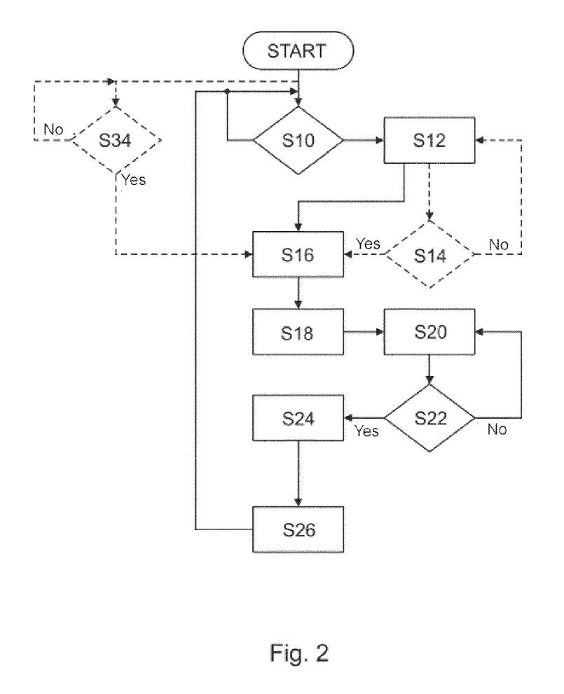

The following describes, with reference to the flow diagram shown in FIG. 2, how a communication connection for the data transmission between the display apparatus 10 and the tablet PC 14 is established and disconnected again.

The firmware configures the controller 20 such that it can detect the following events: activation of the push button 22 and certain, in particular critical operating states of the switch apparatus 18, which it receives via the interface 24.

In a first step S10, the firmware therefore transfers the controller 20 into a state in which it waits for operating state, in particular critical operating states, indicated by the switch apparatus 18 via the interface 24. As soon as the controller detects in step S10 that a specified operating state has been received by the switch apparatus 18 via the interface 24, it continues with step S12, in which it actuates the multicolor light-emitting diode 16 such that the detected operating state indicated by the switch apparatus 18 is accordingly displayed visually, for example by a red or yellow flashing light-emitting diode 16 in the event of a critical operating state of the switch apparatus 18.

The controller 20 can then either continue immediately with step S16, in which it activates the radio module 12, or the controller 20 can first check in a step S14 whether the push button 22 was activated before it continues with step S16 and activates the radio module 12. Step S16 can also be reached directly via step S34 along the branch shown on the left in the flow diagram. For this purpose, step S34 is carried out by the controller 20 concurrently with step S10 and also allows direct activation of the radio module 12 by means of an activation of the push button 22, even without the occurrence of a specified operating state of the switch apparatus 18, for example for a diagnosis of the switch apparatus 28 via the tablet PC 14. If, for example, a toggle or rotary switch having three switching states, i.e. three switch positions, is used as the push button 22, it can be checked in step S14 whether the rotary switch has a first switch position, for example rotated to the right, and in step S16 it can be checked whether the rotary switch has a second switch position, for example rotated to the left. In a third, central position of the rotary switch, the display apparatus 10 can, for example, be deactivated or locked such that no activation of the radio module 12 is possible in this switch position.

Following activation of the radio module 12 in step S16, the controller 20 initiates a log-in process so that an external device such as the tablet PC 14 can be connected wirelessly to the display apparatus 20. This log-in process can be the switching of the radio module 12 into a state in which it accepts the connect requests of external devices such as the tablet PC 14, optionally after inputting a specified code on the external device 14.

When the log-in process has been completed and a wireless interface of the tablet PC 14 has established a wireless connection to the radio module 12, the controller 20 controls the transmission of data, which it has received from the switch apparatus 18 via the interface 24, to the tablet PC 14 and vice versa. The data can, in particular, be diagnosis and measured data, which cannot be displayed via the multicolor light-emitting diode 16. Furthermore, the data can also include service commands input by operators via an appropriate program on the tablet PC 14 and are transmitted to the display apparatus 10 in order, for example, to change the operating state of the switch apparatus 18, in particular to bring it into a non-critical state. The service commands can, for example, be commands to set and/or change the operating parameters of the switch apparatus 18.

In a further step S22, the controller 20 detects the end of the data transmission. The controller 20 can recognize the end of the data transmission in particular as a confirmation command received by the tablet PC 14 via the received data. Of course, other end criteria are possible, for example activation of the push button 22 (in the case of manual interruption) or if the controller 20 detects that no more data is available for transmission.

As soon as the end has been detected, the controller 20 continues with step S24, in which it initiates a log-out process for breaking the wireless connection between the radio module 12 and the wireless interface of the tablet PC 14. In the simplest case, the controller 20 can, for example, simply deactivate the radio module 12 such that the wireless connection between the tablet PC 14 and the radio module 12 is broken. Alternatively, the controller 20 can transmit an explicit command to the tablet PC 14 via the wireless connection such that it logs out.

If the log-out process has been completed, the controller 20 actuates the multicolor light-emitting diode 16 in step S26 such that, if the operating state of the switch apparatus 18 has been changed by corresponding commands received from the tablet PC 14, the updated operating state of the switch apparatus 18 is indicated visually. If, for example, the critical operating state of the switch apparatus 18 has been remedied, the controller 20 can activate the multicolor light-emitting diode 16 such that it continually emits a green light.

As a result of the present invention, a display apparatus which is provided for indicating operating states of other devices is developed such that the limited indication possibilities of an MCI hitherto implemented by a multicolor light-emitting diode, are increased in that a device, such as a mobile computer, configured to communicate with the display apparatus can be used to display further information. In order to allow as efficient a connection as possible between the display apparatus and an external device via a wireless connection, a precisely defined log-in and log-out procedure of the external device is specified, which above all helps to prevent errors in the connection of the external device to a plurality of such display apparatuses. The invention also prevents a wireless interface of the display apparatus from being constantly activated, which is undesirable in certain environments.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE NUMERALS

10 MCI
12 Radio module
14 Tablet PC
16 Multicolor light-emitting diode
18 Circuit breaker/motor starter/motor protection switch
20 Controller
22 Push button
24 Interface to circuit breaker/motor starter/motor protection switch 18

1. A display apparatus, comprising:
a wireless interface, configured to enable communication between the display apparatus and a communication device configured to communicate with the display apparatus;
a multicolor display element configured to display an operating state of a switch apparatus which is connected to the display apparatus; and
a controller, configured to control the multicolor display element and the communication via the wireless interfaces
wherein the controller is further configured to activate the wireless interface and to initiate a log-in process for connecting the display apparatus to the device via the wireless interface when a specified event occurs, to transmit data to the communication device via the wireless interface in a data transmission process, and to initiate a log-out process for breaking connection between the display apparatus and the communication device after the data transmission process has ended.

2. The apparatus of claim 1, wherein the controller is configured to detect an activation of a push button as a specified event.

3. The apparatus of either claim 1, wherein the controller is configured to detect a confirmation command from the communication device as an end of the data transmission.

4. The apparatus of claim 1, wherein the controller is configured to activate the multicolor display element so as to display a specified operating state of the switch apparatus connected to the display apparatus after the connection has been broken between the display apparatus and the communication device.

5. The apparatus of claim 1, wherein the controller is configured to transmit, to the communication device, service notifications as data.

6. The apparatus of claim 4, further comprising
a manual activation element, connected to the controller, and.
wherein the wireless interface is a radio module, which is integrated in the manual activation element together with the multicolor display element.

7. A communication device, comprising:
a wireless interface, including a processor, which is programmed such that the communication device can communicate via the wireless interface with the display^{,} apparatus according to claim 1, and
wherein the wireless interface can receive data from the display apparatus by using data transmission and display the data on a screen.

8. A method for controlling a connection of the display apparatus of claim 1 to a communication device, the method comprising:
detecting a specified event;
activating the wireless interface of the display apparatus depending on the detection of the specified event;
initiating a log-in process to connect the display apparatus tea the communication device via the wireless interface;
transmitting data to the communication device via the wireless interface;
detecting an end of the data transmission; and
initiating a log-out process to interrupt the connection between the display apparatus and the communication device.

9. The method of claim 8, further comprising:
activating the multicolor display element so as to display a specified operating state of the switch apparatus connected to the display apparatus after the connection has been broken between the display apparatus and the communication device, and/or
wherein the detecting includes detection of an activation of a push button and/or detection of an occurrence of a specified operating state of a switch apparatus connected to the display apparatus, and/or
the detecting includes receiving a confirmation command from the communication device.

10 . The method of claim 8, implemented as part of firmware of the display apparatus,
wherein the firmware is executed by the controller to operate the display apparatus.

11. The device of claim 7, wherein the wireless interface is configured generate a confirmation command to end the data transmission and transmit the data to the display apparatus.

12. The apparatus of claim 1, wherein the controller is configured to detect an occurrence of a certain operating state of the switch apparatus connected to the display apparatus.

13. The apparatus of claim 1, wherein the controller is configured to detect an activation of a push button as a specified event and an occurrence of a certain operating state of the switch apparatus connected to the display apparatus.

14. The apparatus of claim 1, wherein the controller is configured to transmit, to the communication device, operating parameters of the switch apparatus connected to the display apparatus as data.

15. The apparatus of claim 1, wherein the controller is configured to transmit, to the communication device, service notifications and operating parameters of the switch apparatus connected to the display apparatus as data.

16. The apparatus of claim 6, wherein the manual activation element can be locked mechanically.
